(19) United States
(12) Patent Application Publication
(10) Pub. No.: US 2009/0244937 A1
(43) Pub. Date: Oct. 1, 2009

(54) DC BUS VOLTAGE HARMONICS REDUCTION

(75) Inventor: Yanzhen Liu, New Berlin, WI (US)

Correspondence Address: Occhiuti Rohlicek & Tsao LLP, 10 Fawcett Street, Cambridge, MA, 02138, US

(73) Assignee: American Superconductor Corporation, Devens, MA (US)

(21) Appl. No.: 12/057,856

(22) Filed: Mar. 28, 2008

(51) Int. Cl. H02M 1/15

(52) U.S. Cl. 363/46

(57) ABSTRACT

In one aspect, in general, the invention features a control system configured for use with a three-phase PWM converter. The control system receives an input signal from a three-phase power supply and provides an output signal at a DC link. A voltage-separating module generates on the basis of the input signal a positive sequence voltage component and a negative sequence voltage component in a rotating reference frame. A reference current computation module uses at least the positive sequence voltage component and the negative sequence voltage component to compute a first reference current and a second reference current. A current regulating module uses at least the first reference current and the second reference current to generate a command signal. The command signal is provided to a driving circuit of the three-phase PWM converter for generating a regulated DC bus voltage at the DC link.

### BACKGROUND

This invention relates to power conversion systems that generate regulated direct current (DC) bus voltages from an alternating current (AC) power supply.

Electricity generated by power plants is delivered via utility grids to power consuming facilities or loads in the form of three-phase alternating current. However, AC power is not always suitable for end use and sometimes needs to be converted into usable forms (e.g., DC) before being connected to a load. In such case, an AC/DC converter is used. In general, an AC/DC converter receives AC power at its input terminal and outputs DC power at its DC link. To produce satisfactory outputs, an AC/DC converter is often operated with a controller, which regulates the waveform and magnitude of DC bus voltage at a desired level.

Among various types of AC/DC converters, one in particular—Pulse Width Modulation (PWM) controlled AC/DC converters—has gained increasing popularity in the past decade. PWM AC/DC converters offer several advanced features over traditional converters, such as sinusoidal input current at unity power factor and high quality output voltage at the DC bus. Therefore, PWM converters can be used in a wide range of applications, including magnet power supplies, DC motor drives, wind turbine applications and utility interactive photovoltaic systems.

One example of a PWM AC/DC converter is shown in FIG. 1. In this example, an AC/DC converter 100 receives at an input terminal 110 an AC power including three-phase voltage inputs eₛₐ, e_{sb}, and e_{sc}, each having a differential phase of 120° from the others. Current inputs iₛₐ, i_{sb}, and i_{sc}, also in AC waveforms, flow through selected lines into a switching circuit 120 in the converter 100. The switching circuit 120 has six switching devices (e.g., diodes, IGBT or integrated gate bipolar transistors, etc) arranged in pairs, including S1, /S1, S2, /S2, S3 and /S3 as shown in the figure. Each pair of switching devices is associated with one phase of the AC power, and their duty cycles in combination define the waveform and magnitude of output voltage V_{dc}. A PWM controller 130 controls a set of gate signals 140 for opening and closing the switching devices in specific sequences, so that a substantially constant voltage V_{dc} can be maintained at a prescribed level V_{dc}* across positive and negative DC buses 152 and 154, respectively.

Several control schemes exist for DC bus voltage regulation. In most cases, the controller 130 detects an error between the actual and prescribed voltage levels and drives the switching devices with controlled PWM gate signals sufficient for compensating the error. In some cases, a larger DC link capacitor 160 may also be used across DC buses to help maintain the output voltage at the desired level. By reducing voltage distortion and current ripple, PWM controlled AC/DC converters can provide high quality voltage output at the DC link.

However, such performance is not necessarily guaranteed under unbalanced input voltage conditions, which may occur in real systems for many reasons. For example, nonlinear loads, nonsymmetrical transformer windings or transmission impedances in the circuit, and accidental shorting of one phase to the ground could all lead to unequal drop/rise of voltage amplitudes in three phases and result in unbalanced input conditions.

Regardless of the cause, one common characteristic of unbalanced input voltage conditions is the appearance of negative-sequence component in the input. Negative-sequence component causes even harmonics in the DC link voltage and odd harmonics in the converter current, which can significantly deteriorate the quality of DC power supplied to the load. Under extreme conditions, it may even lead to a system trip if maximum DC bus voltage is exceeded. In large power conversion systems, these problems can grow in severity as the number of converters connected to a common AC link increases.

### SUMMARY

In one aspect, in general, the invention features a control system configured for use with a three-phase PWM converter. The control system receives an input signal from a three-phase power supply and provides an output signal at a DC link. A voltage-separating module generates on the basis of the input signal a positive sequence voltage component and a negative sequence voltage component in a rotating reference frame. A reference current computation module uses at least the positive sequence voltage component and the negative sequence voltage component to compute a first reference current and a second reference current. A current regulating module uses at least the first reference current and the second reference current to generate a command signal. The command signal is provided to a driving circuit of the three-phase PWM converter for generating a regulated DC bus voltage at the DC link.

Embodiments may include one or more of the following features.

The input signal includes an input voltage signal and an input current signal.

A voltage detection circuit provides a first, a second, and a third phase input voltage component to the voltage-separating module on the basis of the input voltage signal.

A three phase to two phase voltage transformer generates two phase α and β axis voltage components on the basis of the first, second and third phase input voltage components. A stationary to rotating reference frame voltage converter generates rotating d and q axis voltage components in the rotating reference frame on the basis of the α and β axis voltage components. The rotating reference frame has a phase determined by an angle signal.

A phase locked loop generates the angle signal on the basis of a selected one of the rotating d and q axis sequence components.

The rotating d axis sequence component includes a positive and negative d axis sequence component. The rotating q axis sequence component includes a positive and negative q axis sequence component.

A current detection circuit provides a first, a second, and a third phase input current component on the basis of the input current signal.

A three phase to two phase current transformer generates two phase α and β axis current components on the basis of the first, second, and third phase input current components. A stationary to rotating reference frame current converter generates rotating d and q axis current components in the rotating reference frame on the basis of the α and β axis current components.

A DC link voltage detection circuit provides a DC bus voltage signal on the basis of the output signal at the DC link.

A DC link voltage regulator receives a pre-determined DC bus reference voltage signal for generating a DC bus reference current signal on the basis of the DC bus voltage signal.

The reference current computation module uses the DC bus reference current signal to compute the first reference current and the second reference current. The first reference current includes a rotating d axis reference current. The second reference current includes a rotating q axis reference current.

A d-axis current regulator generates a first correction voltage signal. A q-axis current regulator generates the second correction voltage signal. A first summer provides a first reference voltage on the basis of the first correction voltage signal. A second summer provides a second reference voltage on the basis of the second correction voltage signal. The first and second reference voltages are used for generating the command signal.

The DC link voltage regulator includes a proportional integral regulator.

The d-axis current regulator includes a proportional integral regulator and may further include an infinite sine gain unit.

Similarly, the q-axis current regulator includes a proportional integral regulator and may further include an infinite sine gain unit.

The DC link voltage detection circuit further includes a low pass filter.

Among other features and advantages, the invention provides a control system for reducing 2^{nd} order DC bus voltage harmonics caused by unbalanced input voltages. By eliminating input current distortion and voltage fluctuation at the DC bus, stability of an AC/DC power converter can be improved. In addition, since it is computationally simple to regulate both positive- and negative-sequence current components in the same synchronous reference frame, such control system can be easily integrated with conventional AC/DC power converters. Moreover, when used in large-capacity power systems, e.g., a motor control center having multiple motor drives connected on a common DC bus, satisfactory voltage performance may be achieved without increasing DC bus capacitance, thereby minimizing overall system cost.

Other features and advantages of the invention are apparent from the following description, and from the claims.

### DESCRIPTION OF DRAWINGS

FIG. 1 is a conventional AC/DC power conversion system controlled by PWM gate signals.

FIG. 2 is a block diagram of a control system for reducing DC bus voltage harmonics.

FIG. 3 is a flow chart of the control scheme used in the control system illustrated in FIG. 2.

FIGS. 4A to 4C are illustrative plots of AC-line voltage, DC link voltage, converter line current, respectively.

FIG. 5 is a diagram of the reference current computation module used in FIG. 2.

FIG. 6 is a diagram of the current regulator used in FIG. 2.

FIG. 7 is a diagram of the infinite sine gain used in FIG. 6.

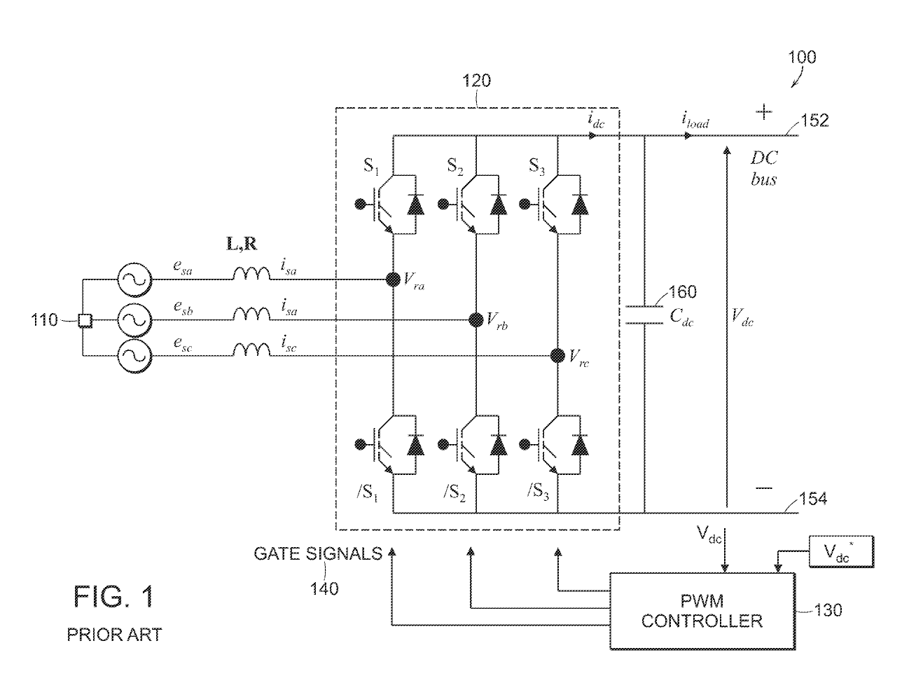

### DETAILED DESCRIPTION

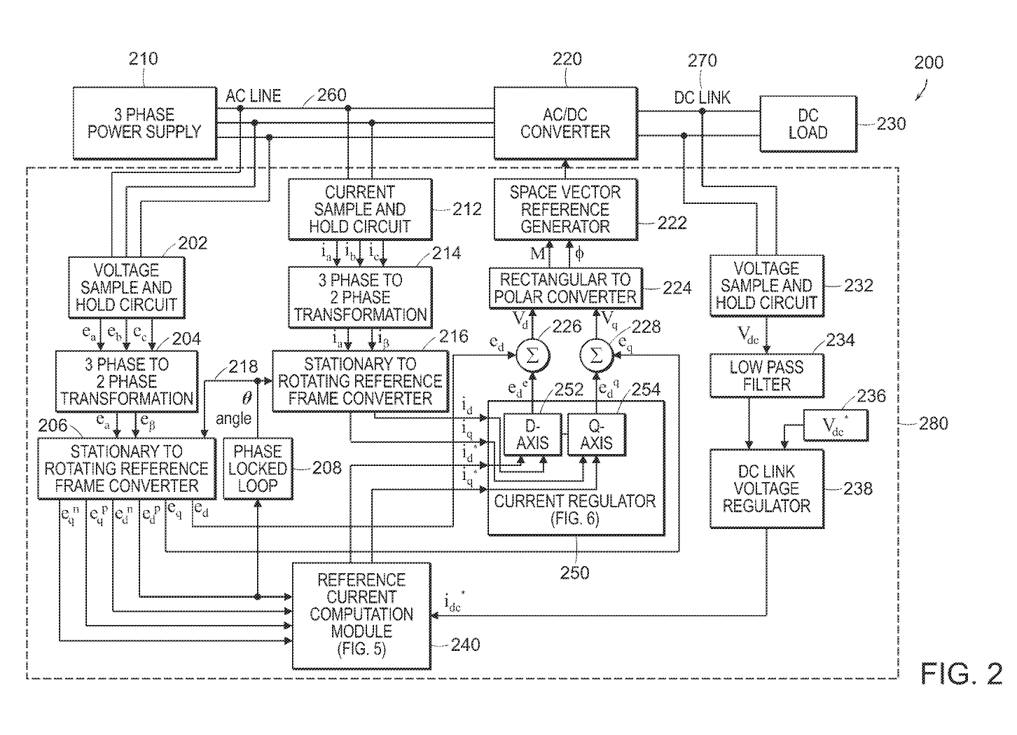

Referring to FIG. 2, an AC/DC power conversion system 200 includes an AC/DC converter 220 coupled between a three phase power supply 210 and a DC load 230. The AC/DC converter 220 operates in a PWM mode to convert alternating current provided by the power supply 210 at AC line 260 to direct current at DC link 270 to supply the load 230. For the reasons discussed above, unbalanced input voltage conditions may occur and cause 2^{nd} order harmonics in output voltage at the DC link 270, which can affect converter performance and system stability. Therefore, a PWM control system 280 is used in conjunction with the converter 220 for controlling DC bus voltage under unbalanced input conditions. In particular, 2^{nd} order harmonics at the DC link 270 is desired to be regulated.

The control system 280 includes a voltage sample and hold circuit 202, which samples AC line input voltage and provides digitized three-phase voltage signals eₐ, e_{b}, and e_{c} to a three phase to two phase transformer 204. The transformer 204 transforms three phase signals into two phase quantities in a stationary α-, β-coordinate system. The output of the transformer 204 (i.e., e_{α} and e_{β}) is converted by a stationary to rotating reference frame converter 206 to d- and q-axis components (i.e., e_{d} and e_{q}) in a rotating reference frame defined by a phase angle θ. In this rotating reference frame, positive and negative sequence components e_{d}^{p}, e_{d}ⁿ, e_{q}^{p}, e_{q}ⁿ of the voltage signals e_{d} and e_{q} are also obtained, whereas non-zero values of negative sequence components e_{d}ⁿ and e_{q}ⁿ indicate the presence of unbalanced voltage conditions.

Next, positive and negative voltage components e_{d}^{p}, e_{d}ⁿ, e_{q}^{p} and e_{q}ⁿ are delivered to a reference current computation module 240 for computing reference current signals i_{d}* and i_{q}*. Another input signal used by the reference current computation module 240 is a DC bus reference current signal i_{dc}*, provided by a DC link voltage regulator 238. DC link voltage regulator 238 is used for regulating DC bus voltage V_{dc} to a pre-determined level V_{dc}* 236, and accordingly, its output i_{dc}* represents the current level required at the DC bus for this purpose. A voltage sample and hold circuit 232 samples actual DC bus voltage V_{dc}, which is sometimes filtered by a low pass filter 234 before reaching the DC link voltage regulator 238.

Using i_{dc}* and the four voltage components, the reference current computation module 240 outputs reference current signals i_{d}* and i_{q}* to a current regulator 250, which then compares actual input current signals i_{d} and i_{q} with references i_{d}* and i_{q}* to determine error signals i_{d}^{e} and i_{q}^{e}, respectively. Like input voltage signals e_{d} and e_{q}, input current signals i_{d} and i_{q} are obtained from AC line 260 via a current sample and hold circuit 212, a three phase to two phase transformer 214, and a stationary to rotating reference frame converter 216.

The current regulator 250 includes a d-axis regulator 252 and a q-axis regulator 254, in which correction voltages e_{d}^{e} and e_{q}^{e} sufficient for correcting current errors i_{d} and i_{q}^{e} are computed, respectively. Correction voltages e_{d}^{e} and e_{q}^{e} are then summed with input voltage signals e_{d} and e_{q} (previously generated by converter 206) in summers 226 and 228 to obtain reference voltage signals V_{d} and V_{q}, which ultimately determines gate signals for the converter 220 and the level of current that needs to be injected to the DC bus.

Upon receiving reference voltages V_{d} and V_{q}, a rectangular to polar converter 224 converts these d- and q-axis components into magnitude M and phase angle Ø in a polar coordinate system, and sends them to a space vector reference generator 222 (also refereed to herein as a driving circuit). Using M and Ø, the space vector reference generator 222 computes PWM gate signals and drives the switching devices in the converter 220 with duty cycle arrangements sufficient for achieving the desired DC bus voltage V_{dc}*. For example, if the actual DC bus voltage V_{dc} is found to be lower than the desired level V_{dc}*, PWM gate signals will adjust to changes in duty cycle arrangements so that additional current is injected into DC bus to raise the magnitude of V_{dc}.

Note in the current regulator 250, both negative and positive sequence current components are regulated simultaneously in the same synchronous reference frame. Thus, to ensure that the rotating reference frame of i_{d} and i_{q} (created in converter 216) is consistent with that of i_{d}* and i_{q}* (created in converter 206), a phase locked loop 208 is used to lock both d-, q-coordinate systems to the same synchronous reference frame angle θ 218. In this example, the reference frame angle θ is determined based on d-axis positive sequence component e_{d}^{p}, since positive sequence component often has a greater magnitude than negative sequence component therefore is easier to implement the phase lock. However, in some other examples, it is also possible to lock phase on the negative sequence, e.g., e_{d}ⁿ or e_{q}ⁿ.

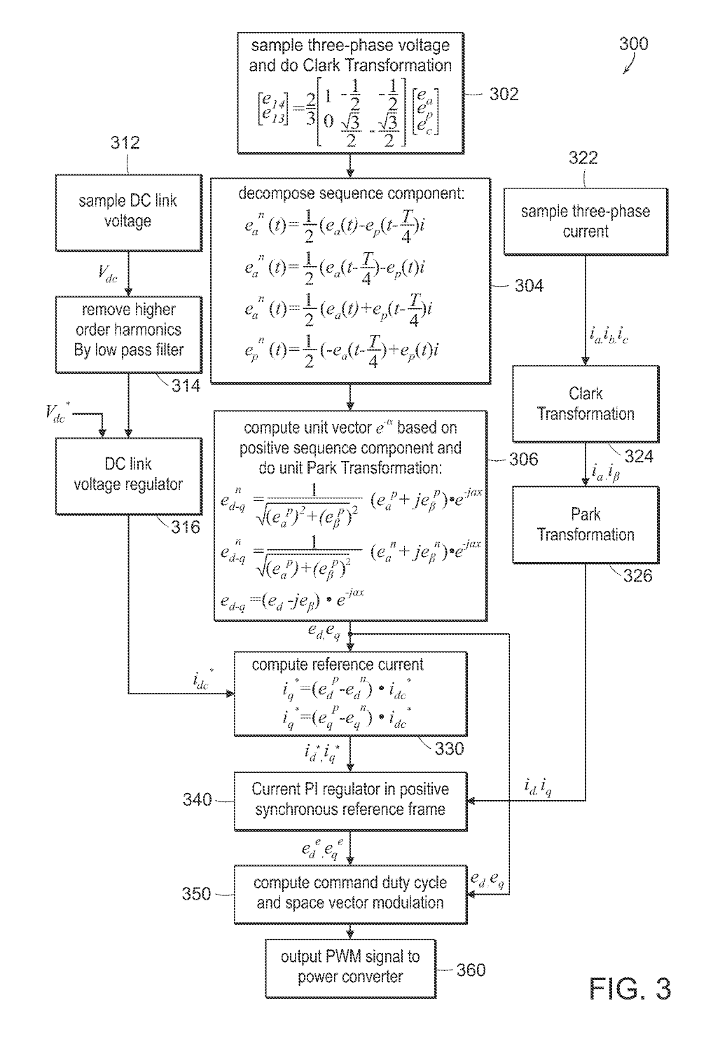

Referring to FIG. 3, the logics and functions of several control modules used in the above converter system 200 are further illustrated in a flow chart 300. Initially, in step 302, three phase voltages signals eₐ, e_{b}, and e_{c} retrieved by the voltage hold and sample circuit 202 are transformed into two phase stationary α-, β-coordinates using Clark Transformation, as given by:

$$[ \begin{matrix}{e}_{α} \\ {e}_{β}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{e}_{α} \\ {e}_{b} \\ {e}_{c}\end{matrix} ] \qquad ( 1 )$$

where e_{α} and e_{β} are the input voltage signals projected on the stationary α-, β-coordinate system.

In step 304, positive and negative sequence voltage components are decomposed from e_{α} and e_{β}. There are many ways of decomposing the voltage components. In one example, the positive and negative sequences are obtained as:

$${e}_{α}^{p} ( t ) = \frac{1}{2} ( {e}_{α} ( t ) - {e}_{β} ( t - \frac{T}{4} ) ) \\ {e}_{β}^{p} ( t ) = \frac{1}{2} ( {e}_{α} ( t - \frac{T}{4} ) - {e}_{β} ( t ) ) \\ {e}_{α}^{n} ( t ) = \frac{1}{2} ( {e}_{α} ( t ) + {e}_{β} ( t - \frac{T}{4} ) ) \\ {e}_{β}^{n} ( t ) = \frac{1}{2} ( - {e}_{α} ( t - \frac{T}{4} ) + {e}_{β} ( t ) ) \qquad ( 2 )$$

where T represents the period of AC signal, e.g., 1/60 sec in a common AC line voltage. Here, non-zero values of negative sequence components e_{α}ⁿ and e_{β}ⁿ indicate the occurrence of unbalanced input conditions.

In a next step 306, each sequence component is represented in a rotating reference frame along its d- and q-axis, based on unit Park Transformation, as given by:

$${e}_{d - q}^{p} = \frac{1}{\sqrt{{( {e}_{α}^{p} )}^{2} + {( {e}_{β}^{p} )}^{2}}} ( {e}_{α}^{p} + j {e}_{β}^{p} ) \cdot {e}^{- j ω t} \\ {e}_{d - q}^{n} = \frac{1}{\sqrt{{( {e}_{α}^{p} )}^{2} + {( {e}_{β}^{p} )}^{2}}} ( {e}_{α}^{n} + j {e}_{β}^{n} ) \cdot {e}^{- j ω t} \\ {e}_{d - q} = ( {e}_{α} + j {e}_{β} ) \cdot {e}^{- j ω t} \qquad ( 3 )$$

where ω represents the rotational speed of the rotating frame (e.g., in rad/s), and the reference frame angle θ is calculated as θ=ωt.

As discussed above in the control system 200, positive and negative d- q-voltage components are fed into the reference computation module 240 for computing reference current signals i_{d}* and i_{q}* which are the desired d- and q-axis current components for maintaining DC bus voltage at V_{dc}*. The computation, as illustrated in step 330, is based on the equations of power flow control:

i_{d}*=(e_{d}^{p}−e_{d}ⁿ)·i_{dc}*

i_{q}*=(e_{q}^{p}−e_{q}ⁿ)·i_{dc}* (4)

where i_{dc}* is determined by a DC link voltage regulator in step 316 to be the desired/reference DC bus current for achieving V_{dc}*. Examples of DC link voltage regulators include commonly used PI controllers, which are known to be used for eliminating steady state error in output signals. In some examples, prior to step 316, actual DC bus voltage signal V_{dc} is first processed in step 314 by a low pass filter to eliminate certain harmonics from its waveform, which may otherwise interfere with the determination of i_{dc}* in the voltage regulator.

Upon collecting the reference current signals i_{d}* and i_{q}*, in step 340, the current regulator compares i_{d}* and i_{q}* with sampled AC line current components i_{d} and i_{q} for generating d- and q-axis correction voltages e_{d}^{e} and e_{q}^{e}, respectively. The conversion of i_{d} and i_{q} from three phase signals iₐ, i_{b}, and i_{c} follows a similar set of Clark Transformation 324 and Park Transformation 326 to those described for voltage conversion. Note in this step, both positive current sequences i_{d}^{p}, i_{q}^{p} and negative current sequences i_{d}ⁿ, i_{q}ⁿ are regulated together to the reference levels i_{d}* and i_{q}* in the same positive synchronous reference frame. Examples of the current regulator will be described in greater details later.

In a following step 350, correction voltages e_{d}^{e} and e_{q}^{e} are added to actual line voltage e_{d} and e_{q} to generate reference voltages V_{d} and V_{q}, which allows the space vector generator to compute desired command duty cycles for the switching devices in the converter 220. In a final step 360, PWM gate signals corresponding to the closing and opening sequence of each pair of switching devices are determined and sent to the AC/DC converter.

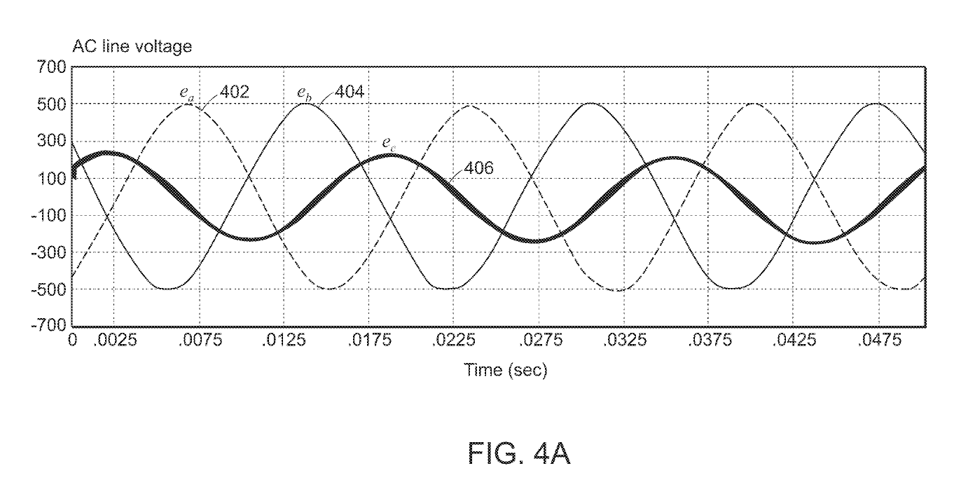

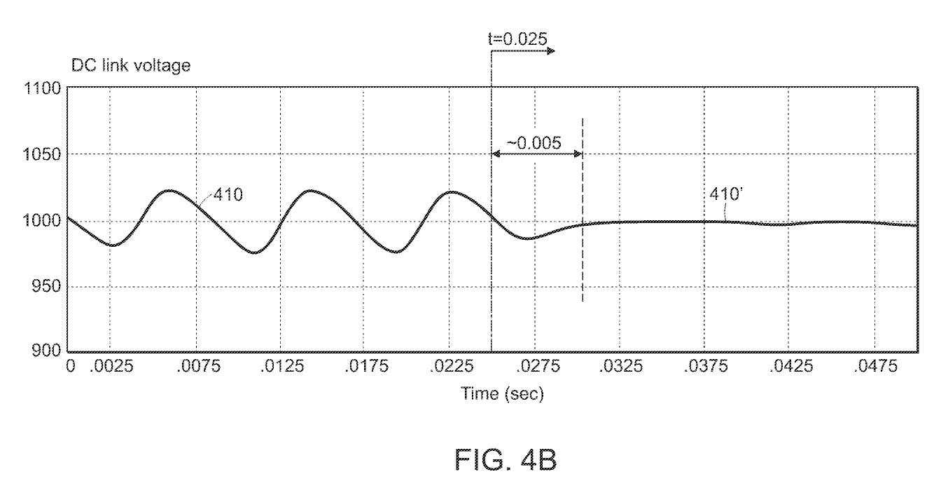

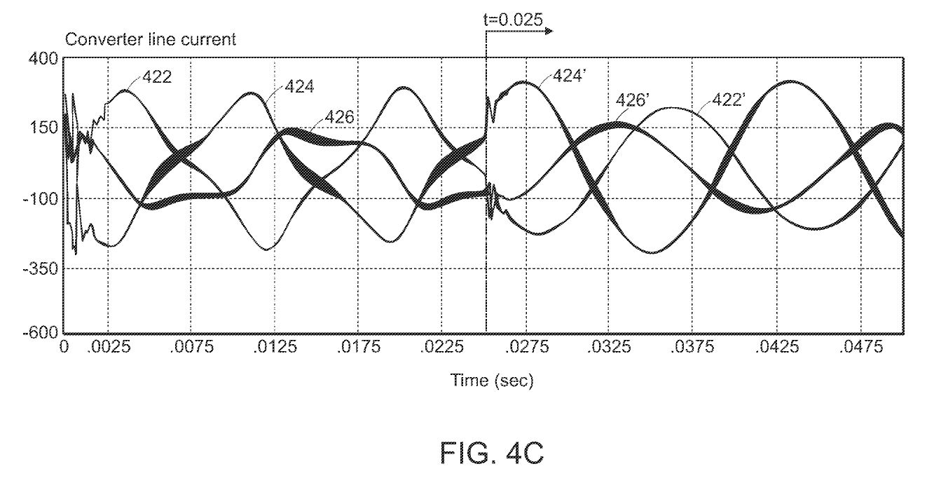

Referring to FIGS. 4A to 4C, for the exemplary control system 280 described in FIG. 2, simulation results of AC line voltage, DC link voltage, and converter input current are shown, respectively. As illustrated in FIG. 4A, voltage supply at the AC line has three sinusoidal waveforms 402 (eₐ), 404 (e_{b}), and 406 (e_{c}) having a differential phase of 120° from each other. In a common 60 Hz system for example, each waveform has a cycle “T” of 0.0167 s. Thus, eₐ leads e_{b} by 0.056 s (i.e., T/3) and e_{c} by 0.11 s (i.e., 2T/3). Note the amplitude of e_{c} is simulated to be only at 50% of the level in eₐ and e_{b}, thereby creating an unbalanced input condition. Without proper control, such imbalance in AC line voltage causes 2^{nd} order (120 Hz) harmonics in DC bus voltage 410, which further causes distortion in converter input current waveforms 422, 424, and 426, as shown in FIGS. 4B and 4C, respectively.

To demonstrate the effect of control system 280, at t=0.025 s, control circuit is activated. Following the activation, as shown in FIG. 4B, DC link voltage quickly adjusts from its original waveform 410 to a post-control waveform 410′ in response to the power flow control. After a transient period of ˜0.005 s, no 2^{nd} order harmonic content can be observed in steady state DC link voltage 410′. Meanwhile, distortions formerly present in converter line current waveforms 422, 434, 426 are also eliminated from steady state waveforms 422′, 424′, and 426′, as shown in FIG. 4C. Unlike DC link voltage or converter line current, AC line input voltage is usually not controlled, thus its original waveforms 402, 404, and 406 are not affected, as shown in FIG. 4A.

Having illustrated the overall control scheme of the PWM control system 280 as well as its voltage regulating effect, several internal modules employed in the control loop are described in greater details below.

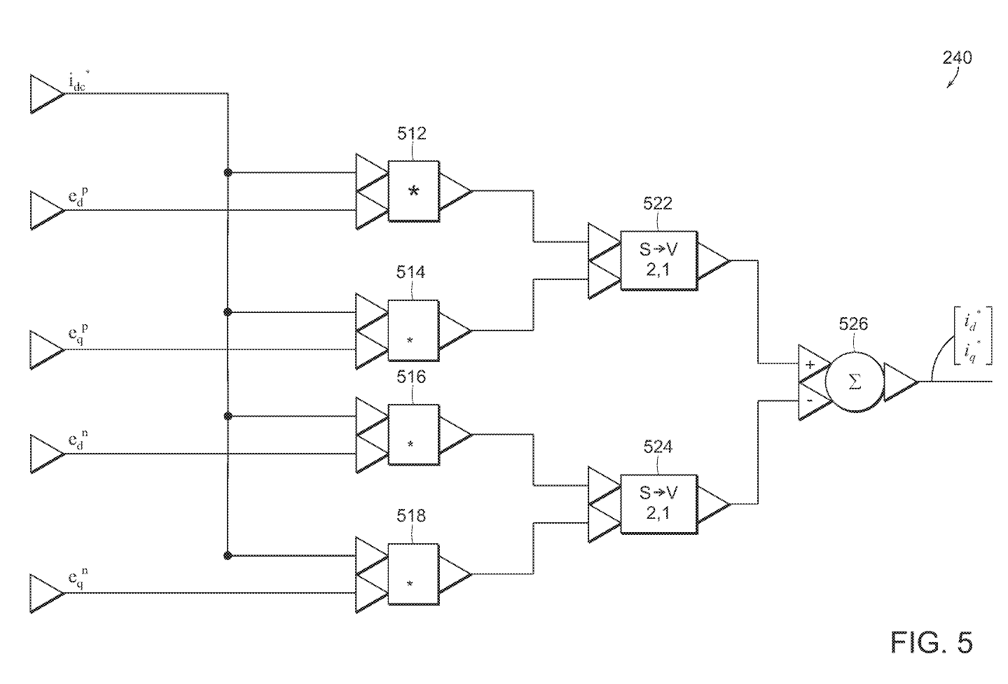

Referring to FIG. 5, an example of the reference current computation module 240 is shown. A current input of the reference current computation module 240, i.e., reference DC bus current i_{dc}*, is multiplied by each of four voltage inputs, including positive sequence components e_{d}^{p} and e_{q}^{p} and negative sequence components e_{d}ⁿ and e_{q}ⁿ, in one of four multipliers 512, 514, 516, and 518, respectively. The scalar outputs of the first two multiplier 512 and 514, indicating the positive sequence power flows along d- and q-axis, are converted by a scalar-vector converter 522 into a positive sequence power flow vector

$$[ \begin{matrix}{{e}_{d}}^{p} & • {{i}_{d c}}^{*} \\ {{e}_{q}}^{p} & • {{i}_{d c}}^{*}\end{matrix} ] .$$

Likewise, the scalar outputs of multiplier 516 and 518 are converted by a second scalar-vector converter 524 into a negative sequence power flow vector

$$[ \begin{matrix}{{e}_{d}}^{n} & • {{i}_{d c}}^{*} \\ {{e}_{q}}^{n} & • {{i}_{d c}}^{*}\end{matrix} ] .$$

A summer 526 then sums the positive sequence power flow vector with the inverted negative sequence power flow vector, and outputs a reference current vector

$$[ \begin{matrix}{{i}_{d}}^{*} \\ {{i}_{q}}^{*}\end{matrix} ] ,$$

representing d- and q-axis reference current i_{d}* and i_{q}*, as defined by equation (4) described earlier.

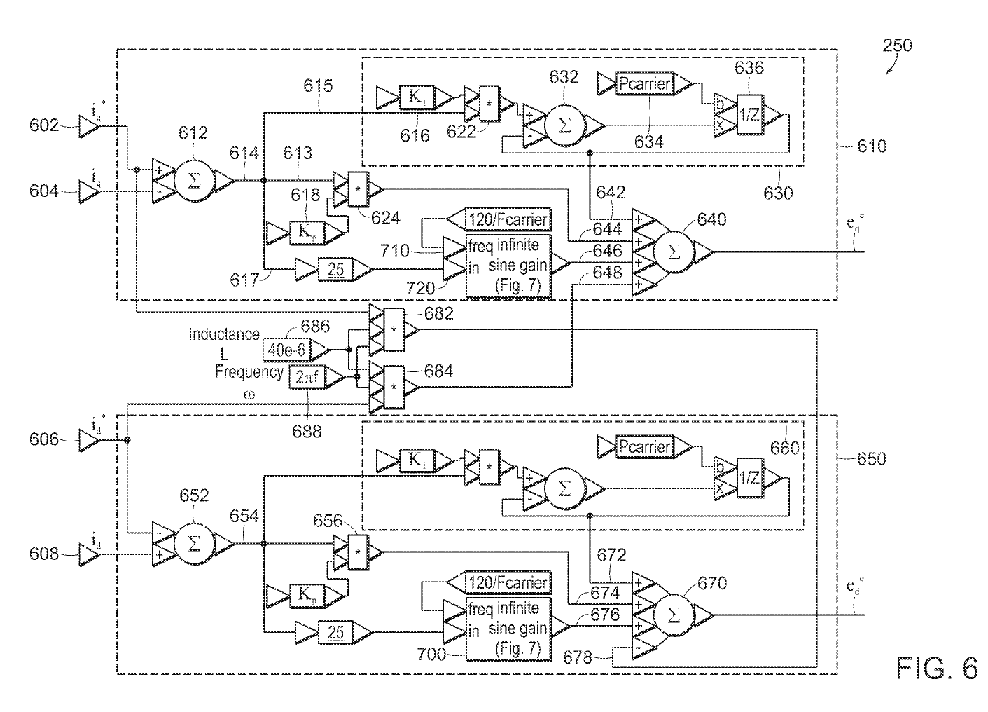

Referring to FIG. 6, an example of the current regulator 250 is shown in greater detail. Inputs to the current regulator 250, including q-axis reference and sampled current components 602 and 604 (i.e., i_{q}* and i_{q}) and d-axis reference and sampled current components 606 and 608 (i.e., i_{d}* and i_{d}) are processed in a q-axis current regulator 610 and a d-axis current regulator 650, respectively. Serving as a proportional integral (PI) regulator in essence, each current regulator determines an error between its two input signals and outputs a correction signal for eliminating the error.

For example, in the q-axis regulator 610, i_{q}* and i_{q} are first received at a positive and negative input terminal of a summer 612, which outputs the error between the reference and sampled q-axis current components, i.e., i_{q}^{e}, in an error signal 614. Next, the error signal 614 flows along signal lines 615, 613, and 617 in parallel and is processed in an integral regulator/integrator 630, a proportional regulator/multiplier 624, and an infinite sine gain 700, respectively, before regulator 610 outputs the correction signal, i.e., q-axis correction voltage e_{q}^{e}.

The integrator 630 integrates in a discrete time domain the error signal 614 multiplied by an integral gain K_{I} 616. That is, the output of the integrator 630 at any clock time tₙ (i.e., X(tₙ)), is equal to the output at a previous clock time tₙ₋₁ (i.e., ΣX(tₙ₋₁)), plus K_{I} times the error signal 614, as given by:

$$X ( {t}_{n} ) = {\sum }_{0}^{n - 1} X ( {t}_{n - 1} ) + {K}_{I} \cdot ( {i}_{q}^{*} ( {t}_{n} ) - {i}_{q} ( {t}_{n} ) ) \qquad ( 5 )$$

To implement this integrator, a unit delay element 636 is used. The first input 634 of the unit delay element 636, i.e., Pcarrier, is a system clock signal. By feeding back the output signal 642 to its input through a summer 632, error signal is integrated at a clock signal pulse. This integral output 642 is then provided to a four-input summer 640 as a first input signal.

A second input signal 644 of the summer 640 is the proportional output of the error signal 614, which is simply the error signal multiplied by a proportional gain 618, Kₚ, as given by Kₚ (i_{q}*−i_{q}).

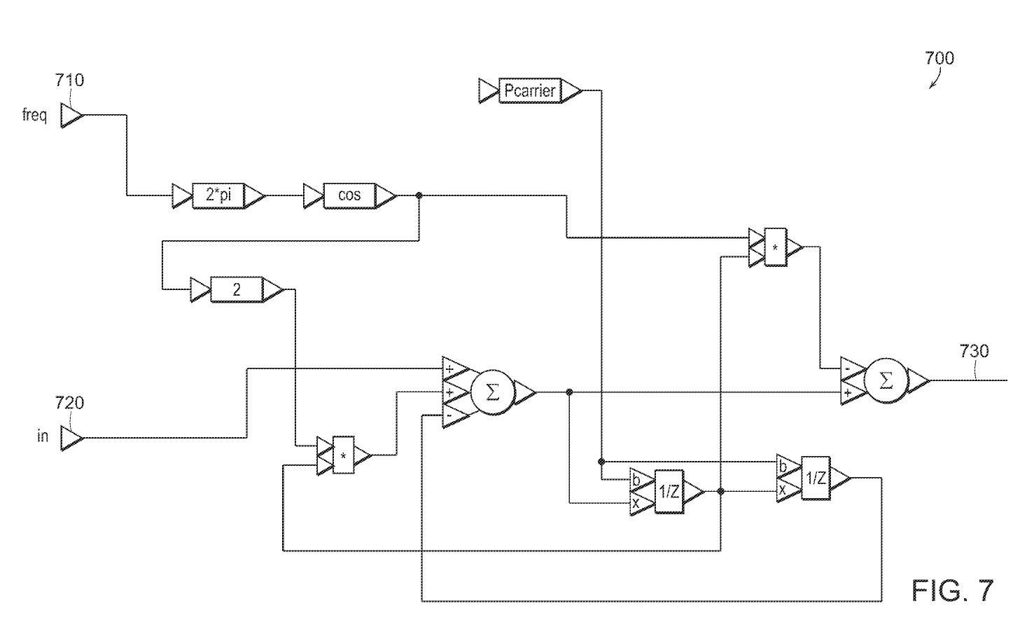

A third input signal 646 of the summer 610 is coupled to an output of an infinite sine gain unit 700, the internals of which is also shown in FIG. 7. Infinite sine gain unit in general functions as an undamped oscillator having a substantially infinite gain at a predetermined frequency 710. That is, in response to any finite input 720, the output signal at the predetermined frequency 710 increases in proportion to time without limit. This characteristic is determined by the following transfer function T(s), as given by:

$$T ( s ) = \frac{s}{{s}^{2} + {{ω}_{0}}^{2}} \qquad ( 6 )$$

where s=σ+jω, a complex variable in Laplace domain, and ω₀ is a predetermined frequency. The magnitude of the transfer function T(s) at an input frequency of ω=ω₀ can be obtained by simply replacing the variable s with jω₀, as given below:

$$T ( {jω}_{0} ) = \frac{s}{{( {jω}_{0} )}^{2} + {{ω}_{0}}^{2}} \qquad ( 7 )$$

With the denominator equal to zero, this unit has an infinite gain at ω₀.

In the context of the q-axis regulator 610 as shown in FIG. 6, the infinite sine gain unit 700 receives a frequency signal 710 that sets the frequency to which this unit 700 is tuned, and outputs a signal 646 representing an input 720 signal at this tune frequency. Here, by fixing the frequency signal 710 at 120/Fcarrier, i.e., twice the frequency of supply voltage divided by system sampling rate, 120 Hz AC component (i.e., 2^{nd} order harmonics) in the current error signal 614 is tracked and provided to the summer 640. As previously discussed, negative sequence component appears as 120 Hz AC component in the positive synchronous frame. Thus, this infinite sine gain unit 700 allows the negative sequence component to be regulated in the same positive synchronous frame as positive sequence component is being regulated by the proportional-integral part (630 and 624) of the current regulator 610.

Now with three summer input signals 642, 644, and 646 described as being only associated with q-axis current components, the fourth input signal 648 of the summer 640 reflects the cross coupling between d- and q-axis current components. For example, the influence of a d-axis current component on the q-axis regulator can be described by the following relationship:

V_{q}^{c}=2π [symbol] f [symbol] L [symbol] i_{d}* (8)

where V_{q}^{c} is the cross coupling term provided as the fourth input to the summer 640, 2π·f is the radian frequency of supply voltage (i.e., 2π*60 Hz), L is the inductance between the converter and harmonic filters across which the feedback voltage is sensed (e.g., at the three phase power supply), and i_{d}* is the d-axis reference current component. Numerical values of L and 2π·f are provided as inputs 686 and 688 to a multiplier 684, which subsequently outputs the cross coupling term 648 to the summer 640.

Having described the q-axis current regulator 610, by which both positive and negative q-axis sequence components are regulated, its counterpart—d-axis current regulator 650 will be described briefly below. Again, in order to regulate both positive and negative d-axis sequence components in the same synchronous reference frame, an integral regulator/integrator 660, a proportional regulator/multiplier 656, and an infinite sine gain unit 700 are implemented in the circuit to provide output signals 672, 674, and 676 to a summer 670, respectively. Note here, a fourth inverting input 678 of the summer 670, representing the cross coupling of q-axis current component on the d-axis regulator 650, is defined as:

V_{d}^{c}=−2π [symbol] f [symbol] L [symbol] i_{q}* (9)

where V_{d}^{c} is the cross coupling term, i_{q}* is the q-axis reference current component, with f and L same as described before. Other units in the d-axis regulator 650 function in a similar way as described in q-axis regulator 610.

Therefore, in the current regulator 250, d-axis and q-axis current signals are regulated in a d-axis and q-axis regulator, respectively, in which both positive and negative sequence components are processed in the same synchronous reference frame.

Referring to FIG. 7, an example of the infinite sine gain unit 700 used in the current regulator 250 is shown in greater detail. Internals of the infinite sine gain unit 700 are further described in U.S. Pat. No. 6,977,827 B2 by Gritter, the disclosure of which is incorporated herein by reference. In addition, examples of three phase to two phase transformers 204 and 214, stationary to rotating reference frame converters 206 and 216, phase locked loop 208, and DC link voltage regulator 238 are also described in U.S. Pat. No. 6,977,827 B2 by Gritter. It will be appreciated by those of ordinary skill in the art that various forms of circuits may be used in these modules for similar functions.

It is to be understood that the foregoing description is intended to illustrate and not to limit the scope of the invention, which is defined by the scope of the appended claims. Other embodiments are within the scope of the following claims.

What is claimed is:

1. A control system configured for use with a three-phase PWM converter that receives an input signal from a three-phase power supply and provides an output signal at a DC link, the control system comprising:
a voltage-separating module for generating on the basis of the input signal a positive sequence voltage component and a negative sequence voltage component in a rotating reference frame;
a reference current computation module using at least the positive sequence voltage component and the negative sequence voltage component to compute a first reference current and a second reference current;
a current regulating module using at least the first reference current and the second reference current to generate a command signal, and to provide the command signal to a driving circuit of the three-phase PWM converter for generating a regulated DC bus voltage at the DC link.

2. The control system of claim 1 wherein the input signal includes an input voltage signal and an input current signal.

3. The control system of claim 2 further comprising a voltage detection circuit for providing a first, a second, and a third phase input voltage component to the voltage-separating module on the basis of the input voltage signal.

4. The control system of claim 3 wherein the voltage-separating module include:
a three phase to two phase voltage transformer for generating two phase α and β axis voltage components on the basis of the first, second and third phase input voltage components; and
a stationary to rotating reference frame voltage converter for generating rotating d and q axis voltage components in the rotating reference frame on the basis of the α and β axis voltage components, the rotating reference frame having a phase determined by an angle signal.

5. The control system of claim 4 further comprising a phase locked loop for generating the angle signal on the basis of a selected one of the rotating d and q axis sequence components.

6. The control system of claim 5 wherein the rotating d axis sequence component includes a positive and negative d axis sequence component and the rotating q axis sequence component includes a positive and negative q axis sequence component.

7. The control system of claim 6 further comprising a current detection circuit for providing a first, a second, and a third phase input current component on the basis of the input current signal.

8. The control system of claim 7 further comprising:
a three phase to two phase current transformer for generating two phase α and β axis current components on the basis of the first, second and third phase input current components; and
a stationary to rotating reference frame current converter for generating rotating d and q axis current components in the rotating reference frame on the basis of the α and β axis current components.

9. The control system of claim 8 further comprising a DC link voltage detection circuit for providing a DC bus voltage signal on the basis of the output signal at the DC link.

10. The control system of claim 9 further comprising a DC link voltage regulator configured to receive a pre-determined DC bus reference voltage signal for generating a DC bus reference current signal on the basis of the DC bus voltage signal.

11. The control system of claim 10 wherein the reference current computation module further uses the DC bus reference current signal to compute the first reference current and the second reference current, wherein the first reference current includes a rotating d-axis reference current, and the second reference current includes a rotating q-axis reference current.

12. The control system of claim 11 wherein the current regulating module includes:
a d-axis current regulator for generating a first correction voltage signal;
a q-axis current regulator for generating the second correction voltage signal;
a first summer for providing a first reference voltage on the basis of the first correction voltage signal;
a second summer for providing a second reference voltage on the basis of the second correction voltage signal;
wherein the first and second reference voltages are used for generating the command signal.

13. The control system of claim 10 wherein the DC link voltage regulator includes a proportional integral (PI) regulator.

14. The control system of claim 12 wherein the d-axis current regulator includes a PI regulator.

15. The control system of claim 14 wherein the d-axis current regulator further includes an Infinite sine gain unit.

16. The control system of claim 12 wherein the q-axis current regulator includes a PI regulator.

17. The control system of claim 16 wherein the q-axis current regulator further includes an Infinite sine gain unit.

18. The control system of claim 9 wherein the DC link voltage detection circuit further comprises a low pass filter.
